(19) United States
(12) Patent Application Publication
(10) Pub. No.: US 2002/0090922 A1
(43) Pub. Date: Jul. 11, 2002

(54) Mobile telephone receivers

(76) Inventors: David Smadja, Crans Sur Sierre (CH); Bruno Bazire, Peymeinade (FR)

Correspondence Address: YOUNG & THOMPSON, 745 SOUTH 23RD STREET 2ND FLOOR, ARLINGTON, VA, 22202

(21) Appl. No.: 09/992,007

(22) Filed: Nov. 26, 2001

(30) Foreign Application Priority Data
Nov. 24, 2000 (FR) 00.15182

(51) Int. Cl. H04B 1/38

(52) U.S. Cl. 455/128; 455/568; 455/90; 455/430

(57) ABSTRACT

A receiver, particularly a mobile telephone receiver, includes a holding element connected to the casing by at least one band slidably retractable therein. This telephone receiver is characterized in that one of the ends of the casing includes a cylindrical rotation element, which is mounted to rotate with respect to the casing about is principal axis to which the band is connected at least in rotation.

### FIELD OF THE INVENTION

The present invention relates to improvements, particularly to mobile telephone receivers, and more especially to means adapted to allow a user to converse easily while having his/her hands free.

### BACKGROUND OF THE INVENTION

Different devices are known which employ one or more bands which are connected to the receiver and which hold it in position on the user's head. Such devices ensure either the rotation of one or more bands with respect to one another or the rotation thereof with respect to the body of the receiver. Devices are also known which ensure retraction of a band in the body of the receiver.

It is an object of the present invention to propose a receiver provided with means for performing two functions, namely, on the one hand, to retract the or each band either inside the casing of this receiver or in another band, or in a holding element connected to the casing, and, on the other hand, to ensure rotation of these bands with respect to said casing.

### SUMMARY OF THE INVENTION

The present invention thus relates to a receiver, particularly a mobile telephone receiver, of the type comprising a casing and a holding element connected thereto by at least one slidably retractable band, characterized in that one of the ends of the casing comprises a cylindrical rotation element which controls rotation of said band with respect to the casing about its principal axis.

Depending on the different embodiments, the band may be fixed on the rotation element or be mounted to slide therein.

As for the rotation element, it may be fixed or mounted to rotate about a real axis or about a virtual axis. This rotation element may thus be mounted to rotate about a physical axis, at least connected in translation with respect to the casing, or be guided in rotation by guiding elements disposed on the periphery thereof. These guiding elements may be constituted by an area in recess or in relief formed on its periphery and by an area of complementary profile formed on a part of the casing which is adjacent thereto.

In an advantageous embodiment of the invention, the casing will have a longitudinal recess hollowed out therein, intended to receive the band when it is introduced into the casing, the radius of curvature of the band and that of this recess having different values, so that the band undergoes an effort of curvature when it is introduced into this recess.

In another embodiment of the invention, the receiver may comprise two parallel bands. Furthermore, the rotation element may be provided with means for indexing its position in rotation which may be constituted by the cooperation of notches provided on the rotation element and of elastic elements provided on the casing, or vice versa.

The device according to the invention has proved particularly advantageous, on the one hand, as it is simple to produce and, on the other hand, by reason of the wide variety of forms of embodiment that can be produced. Finally, it ensures an excellent mechanical hold of the retractable band while allowing the mechanism to retain a very small thickness.

In a variant embodiment of the invention, the band is fast with the cylindrical rotation element and the latter is mounted to slide in a groove provided in the casing. The rotation element comes into contact, when the band is in extracted position, with a circular inner wall of the casing which ensures guiding thereof during rotation.

### BRIEF DESCRIPTION OF THE DRAWINGS

The invention will be more readily understood on reading the following description given by way of non-limiting examples, of various forms of embodiment thereof, with reference to the accompanying drawings, in which:

FIG. 1 is a partial plan view of a telephone receiver according to the invention in position of partial retraction of the band for holding in the casing.

FIG. 2 is a view in transverse section of the receiver shown in FIG. 1 along line II-II thereof.

FIG. 3 is a view in partial longitudinal section of the receiver shown in FIG. 1 along line III-III thereof.

FIG. 4 is a partial view in perspective of the receiver shown in FIGS. 1 to 3 in extracted position, the band being positioned angularly.

FIG. 5 is a view in transverse section of an embodiment of the invention shown in FIG. 4.

FIGS. 6 and 7 are partial views in perspective of a casing equipped with a variant embodiment of a device according to the invention, the band being respectively shown in partially extracted position, and in totally extracted position and positioned angularly.

FIG. 8 is a view in cross-section of the embodiment shown in FIGS. 6 and 7 along line VIII-VIII of FIG. 6.

FIG. 9 is a schematic view of a user wearing a telephone receiver according to one embodiment of the invention.

FIG. 10 is a view in perspective of the receiver shown in FIG. 9 in half-opened out position.

FIG. 11 is a view in perspective of the receiver shown in FIGS. 9 and 10 in rest, or folded position.

FIG. 12 is a partial view in perspective showing the rotation element and foldable and retractable bands connected thereto.

FIG. 13 is a partial view in longitudinal section of the band shown in FIG. 12 on which the rotation element is mounted.

FIG. 14 is a partial plan view of a variant embodiment showing means for indexing the angular position of the band.

FIG. 15 is a partial cross-sectional view of the casing of a receiver according to the invention showing a form of embodiment of the band.

FIG. 16a is a view in perspective of a band and FIG. 16b is a view in perspective of this band disposed in a casing.

### DESCRIPTION OF PREFERRED EMBODIMENTS

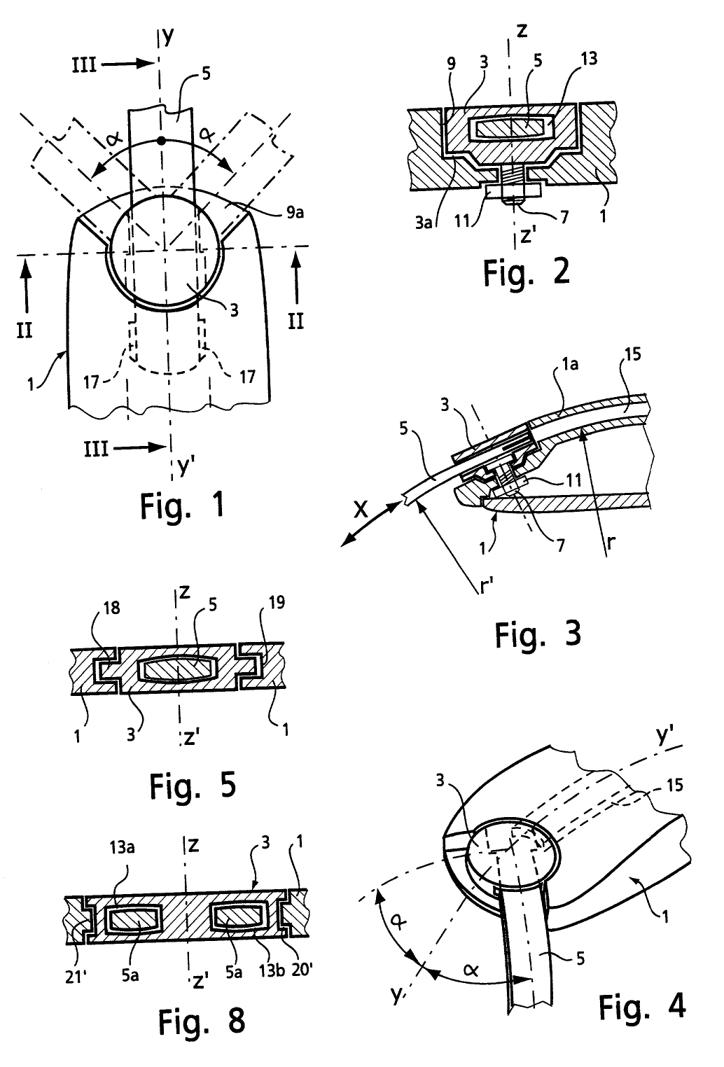

Referring now to the drawings, FIGS. 1 to 4 show a first embodiment of the invention, in which a casing 1 of a telephone receiver comprises at its upper end, i.e. the one located towards the earpiece when the receiver is being used, a rotation element 3 which is at least fast in rotation with a band 5. More precisely, in the present embodiment, the rotation element 3 is traversed by the band 5 of which the so-called outer end (not shown in the drawings) comprises, for example, a holding element intended to hold the receiver on the user's head.

The rotation element 3 is constituted by a cylindrical part of which the lower face is slightly truncated and of which the base 3a is provided, at its centre, with a threaded pin 7. The rotation element 3 is fitted in a cylindrical cavity 9 of the casing 1 which comprises in its upper part a setback 9a which extends on either side of the longitudinal axis yy′ of the casing 1 through an angle α of about 45°.

As shown in FIG. 3, the threaded pin 7 traverses the upper wall 1a of the casing 1 to which it is fixed by a fixing element 11 which allows rotation thereof about the pin 7. The rotation element 3 is pierced, parallel to its upper base, with a recess 13, of rectangular cross-section, which is intended to be traversed by the band 5 whose cross-section is of similar section. As shown in FIG. 3, the upper wall 1a of the casing 1 has an axial and longitudinal recess 15 hollowed out therein which is parallel to the upper face 1a and which, in the present embodiment, is therefore slightly convex and presents a radius of curvature r. This axial recess 15 is intended to receive the band 5. The latter will preferably be constituted by a deformable and elastic material whose radius of curvature r′ will naturally conform to its original shape, therefore different from that of the longitudinal recess 15.

Under these conditions, the band 5 may slide in the recess 13 of the rotation element 3 and, when it is aligned with the longitudinal recess 15 of the casing 1, it may be received therein and move in a movement X in FIG. 3. The difference of radius of curvature between the recess 15 and the band 5 will apply to the latter a deformation which will generate a mild and progressive friction while it is being inserted in and extracted from the recess 15. Stops 17 disposed at the inner end of the band 5 limit the extraction stroke thereof.

Once the band 5 is totally extended, the rotation element 3 may then pivot about its pin 7, which allows the band 5 to occupy an inclined position (angle ′) on either side of the longitudinal axis yy′ of the casing 1.

In a variant embodiment shown in FIG. 5, the axis of rotation of the rotation element 3 is virtual, in that, although the rotation element 3 is well guided in rotation, this guiding is no longer ensured by a physical central axis, but by its periphery. In FIG. 5, this periphery thus forms a circular boss 18 which is positioned in a circular groove 19 of complementary shape, hollowed out in the casing 1. The rotation element 3 can be visible in the upper part of the casing 1, or, on the contrary, be fitted therein.

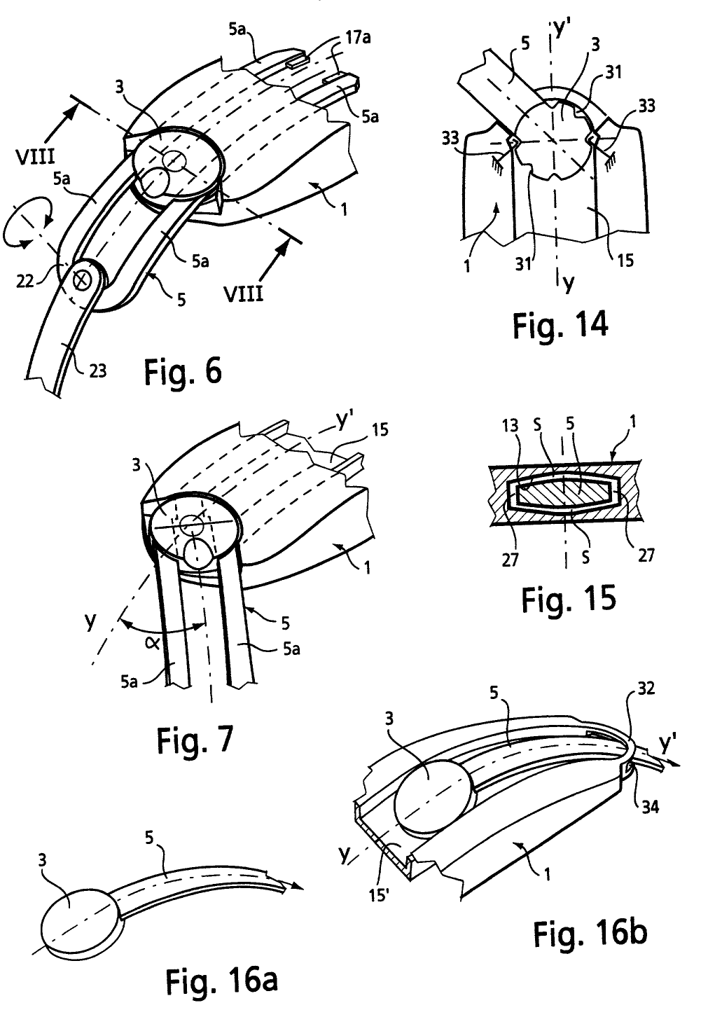

In another variant embodiment of the invention, shown in FIGS. 6 to 8, the band 5 is constituted by two elements 5a and the rotation element 3 in that case comprises two through recesses 13a and 13b in which the band elements 5a are slidably mounted. In the embodiment shown in FIG. 8, the rotation element 3 is guided in rotation by the cooperation of a circular groove 20′ which is made thereon and of a circular boss 21′ made on the casing 1. Any other means for guiding in rotation may, of course, also be employed, and, in particular, the means shown in FIG. 5.

Each of the inner ends of the band elements 5a comprises a stop 17a. The respective outer ends of the band elements 5a are joined, for example, by a portion 22 of arc of circle, as shown in FIG. 6, in order to ensure hold of a means for rotation of a secondary band 23. As in the preceding embodiments, once the band 5 is completely extracted from its housing and the stops 17a are in contact with the rotation element 3, the latter may then rotate about its virtual axis, which allows the band 5 to be positioned in different angular positions α as a function of the user's needs (FIG. 7).

It will be noted that, in such an embodiment of the invention, the element 3 may be a rotation element which is fixed with respect to the casing 1. Insofar as the latter is provided with a circular inner groove whose width is equal to that of the space existing between the two bands, when the stops 17a come into contact with the rotation element 3, the band 5 may then rotate about the groove of the rotation element 3 and thus occupy angular positions forming respective angles α with the longitudinal axis yy′. It will thus be understood that it is unnecessary for the rotation element 3 itself to be rotatable for it to allow rotation of the bands 5.

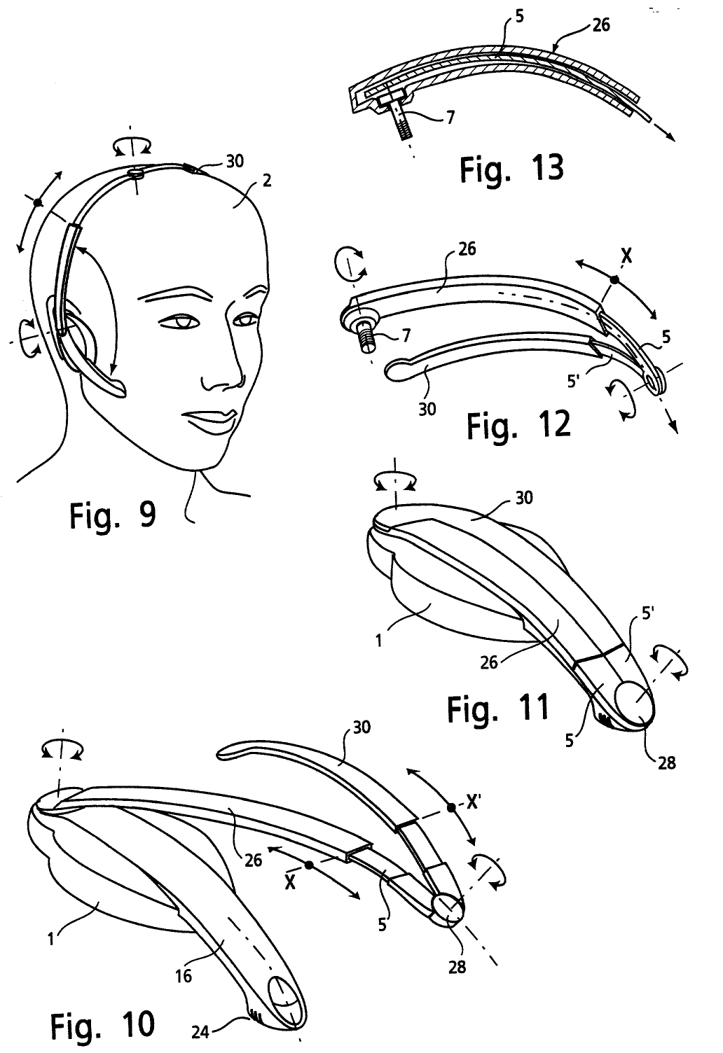

According to the invention, the band 5 may also be hollow in order to receive a secondary band. This applies for example to the embodiment shown in FIGS. 9 to 13.

In these Figures, the receiver is constituted by a casing 1 which extends downwardly, when it is in position on a user's head 2, in an elongated part 1b of which the free end is provided with a microphone 24. The opposite part of the casing 1 receives a sheath 26 which comprises a rotation element constituted by a screw 7 which is fixed on the casing 1 and around which the sheath 26 can rotate. This sheath 26 receives a band 5 which is mounted to slide (displacement X) therein and which terminates in an articulation means 28 on which is arranged a second band 5′, this second band itself being mounted to slide (displacement X′) in a second sheath constituting the element for holding the receiver, i.e. the one which is placed on that part of the user's head 2 opposite the casing 1. The arrangement of the two bands 5, 5′ as well as the articulation means 28 are such that, in position of non-use, or folded position, the two bands 5, 5′ of the receiver are applied against each other in a parallel position, as shown in FIG. 11.

On the contrary, in position of use, the sheath 26 may pivot about the rotation element constituted by the screw 7, and the bands 5 and 5′ may be opened out and disposed substantially in line with each other so as to ensure that the receiver is held in position on the user's head 2, as shown in FIG. 9. Depending on the measurements of the head, the bands 5 and 5′ will be more or less opened out so as to ensure correct hold of the receiver. Rotation of the bands and of the sheath with respect to the casing, about the articulation element 28, will make it possible to adjust the relative angular position existing between them and the part 1b extending the casing 1, as the user desires.

The present device is particularly advantageous in that it allows easy, rapid and precise adjustment and positioning on the user's head 2, while also allowing it to be easily folded into rest position as shown in FIG. 11.

In a particularly advantageous form of embodiment of the invention, the receiver will comprise means for angular indexation of the band or of the sheath with respect to the casing 1. To that end, as shown in FIG. 14, the rotation element 3 is provided, on its periphery, with notches 31 which are intended to receive the ends of elastic elements 33 which are for example constituted by metal blades. It is thus possible, as a function of the number of notches 31 and the positioning thereof, to predefine a series of stable positions of the band 5 on either side of the longitudinal axis yy′ of the casing 1.

Such an indexation may also be effected by any other means and in particular by forming the notches on the lower face of the rotation element 3, and even on an inner part of the band 5. They may also be formed on the casing 1, the spring elements in that case being disposed on the rotation element 3.

The bands and the housings associated therewith may, of course, present very diverse cross-sections. This cross-section may be circular or, for example, be formed by two arcs of circle S in the upper part and lower part and by two vertical lateral sides 27, as shown in FIG. 15.

In the variant embodiment shown in FIGS. 16a and 16b, the inner end of the band 5 is fast with a rotation element constituted by a cylindrical pellet 3, and the upper part of the casing 1 terminates in a rounded wall 32 which is pierced with a slot 34 allowing passage of the band 5. The interior of the casing 1 has a groove 15′ hollowed out therein, whose width is equal to the diameter of the rotation element 3, and which allows the latter to slide in the casing 1 and to be able to occupy a retracted position and an extended position. The width of the slot 34 is sufficient to allow rotation of the band 5, when it is in extended position, through about 45° on either side of the longitudinal axis yy′ of the casing 1. In this embodiment, the rounded form of the wall 32 allows it to ensure correct guiding of the rotation element 3 during its movement of rotation.

What is claimed is:

1.—Receiver, particularly a mobile telephone receiver, of the type comprising a casing and a holding element connected thereto by at least one slidably retractable band,
wherein one of the ends of the casing comprises a cylindrical rotation element which controls rotation of said band with respect to the casing about its principal axis.

2.—The receiver of claim 1, wherein the band is mounted to slide with respect to the rotation element.

3.—The receiver of claim 1, wherein the band is mounted to slide in the rotation element.

4.—The receiver of claim 1, wherein the band is mounted to rotate with respect to the rotation element.

5.—The receiver of claim 1, wherein the band is mounted to slide in a receiving band.

6.—The receiver of claim 1, wherein the receiving band is fast with the rotation element.

7.—The receiver of claim 1, wherein the free end of the band is connected to another band via articulation means.

8.—The receiver of claim 7, wherein the articulation means are such that the bands are capable of occupying a rest position in which they are applied against each other.

9.—The receiver of claim 7, wherein this other band is itself mounted to slide in a sheath fast with the holding element.

10.—The receiver of claim 1, wherein the band is mounted to slide in the casing.

11.—The receiver of claim 1, wherein the rotation element is mounted to rotate about a physical axis fast with the casing.

12.—The receiver of claim 1, wherein the rotation element is guided in rotation by guiding elements disposed on the periphery thereof.

13.—The receiver of claim 10; wherein the casing has a longitudinal recess hollowed out therein, intended to receive the band when it is introduced in the casing, the radius of curvature of the band and that of this recess having different values, so that the band undergoes an effort of curvature when it is being introduced in and extracted from this recess.

14.—The receiver of claim 1, wherein at least one of its bands is formed by two parallel elements.

15.—The receiver of claim 1, wherein the rotation element is provided with means for indexing its position in rotation.
